(19) United States
(12) Patent Application Publication
(10) Pub. No.: US 2011/0222126 A1
(43) Pub. Date: Sep. 15, 2011

(54) INKJET PRINTER AND INKJET PRINTING METHOD

(75) Inventors: Hiroshi Asai, Kyoto (JP); Yuji Kurokawa, Kyoto (JP); Takaharu Yamamoto, Kyoto (JP); Kazuma Kan, Kyoto (JP); Makoto Narazaki, Kyoto (JP)

(73) Assignee: DAINIPPON SCREEN MFG. CO., LTD., Kyoto-shi, Kyoto (JP)

(21) Appl. No.: 13/128,505

(22) PCT Filed: Mar. 4, 2010
(86) PCT No.: PCT/JP2010/053503

§ 371 Date: May 10, 2011

(30) Foreign Application Priority Data
Mar. 19, 2009 (JP) 2009-067668

(51) Int. Cl. H04N 1/60

(52) U.S. Cl. 358/3.06

(57) ABSTRACT

An ejection part (3) in an inkjet printer (1) has ejection mechanisms (31a to 31d) for ejecting fine droplets of colored ink and an ejection mechanism (32) for ejecting fine droplets of clear ink, and a colored image is formed on a colored image print area of print medium (9) by the ejection mechanisms (31a to 31d). By the ejection mechanism (32), the colored image on the print medium (9) is coated with the clear ink and a code image is formed on a blank area around the colored image print area. In the inkjet printer (1), since the coating of the colored image and the forming of the code image are performed with the same clear ink ejected from the one ejection mechanism (32), improvement of wear resistance and improvement of security of the colored image can be achieved while reducing manufacturing cost of the apparatus of the inkjet printer (1).

### TECHNICAL FIELD

The present invention relates to an inkjet printer for performing printing in an inkjet manner and an inkjet printing method.

### BACKGROUND ART

In order to prevent an image, which is printed on a print medium such as a paper, from wear and fading, providing a clear protective layer on the image is conventionally performed. Recently, giving glossiness to a surface of printed material is performed by applying clear ink on a printed image in an overlaying manner.

On the other hand, forming a hologram or a code image (so-called a watermark) on a printed material is performed in order to improve security such as prevention of forgery of printed material. For example, in an electrophotographic printer, a technique of forming a transparent image on a print medium with clear toner (so-called security toner) is known.

In a card printer, disclosed in Japanese Patent Application Laid-Open No. 11-268457, for making an ID card or the like, two overcoat units each of which transfers an overcoat film with thermocompression onto a plastic card where an image, texts or the like has been transferred are provided. After an overcoat film including a hologram is transferred onto the whole surface of the plastic card by one overcoat unit, a protective overcoat film is transferred onto the plastic card by the other overcoat unit.

In the card printer in Japanese Patent Application Laid-Open No. 11-268457, since two-time film transfer process is required and operation of overcoating for the plastic card is complicated, there is a limit to increase production efficiency. In addition, since the plurality of overcoat units are required, the structure of the card printer is also complicated. Furthermore, waste material such as a supporting film to support the overcoat film before transfer is generated after transfer of film.

### SUMMARY OF INVENTION

The present invention is intended for an inkjet printer. It is an object of the present invention to achieve improvement of wear resistance and improvement of security of a colored image on a print medium while reducing manufacturing cost of the apparatus. It is also an object of the present invention to achieve property modification of print medium and improvement of security of a colored image on the print medium while reducing manufacturing cost of the apparatus.

The inkjet printer comprises: an ejection mechanism for ejecting fine droplets of clear ink from a plurality of outlets; a moving mechanism for moving a print medium relative to the ejection mechanism; and a print controller which controls the ejection mechanism and the moving mechanism, to coat a colored image on the print medium with the clear ink and to form a code image on the print medium with the clear ink. It is therefore possible to achieve improvement of wear resistance and improvement of security of the colored image on the print medium while reducing manufacturing cost of the apparatus.

According to a preferred embodiment of the present invention, the print medium is sheet-like or thin plate-like, and the code image is formed on a blank area around the colored image on a main surface of the print medium. More preferably, forming the code image with the clear ink is performed in parallel with coating the colored image with the clear ink by the print controller. Still more preferably, the ejection mechanism passes each position on the print medium once by one-time relative movement of the print medium, to complete forming the code image with the clear ink and coating the colored image with the clear ink.

According to another preferred embodiment of the present invention, the code image is formed on the colored image.

According to still another embodiment of the present invention, the print medium is sheet-like or thin plate-like, and the colored image is formed on one main surface of the print medium and the code image is formed on the other main surface of the print medium.

According to another aspect of the present invention, the inkjet printer comprises: an ejection mechanism for ejecting fine droplets of clear ink from a plurality of outlets; a moving mechanism for moving a print medium relative to the ejection mechanism; and a print controller which controls the ejection mechanism and the moving mechanism to modify a surface of the print medium, to be printed with a colored image, by uniformly ejecting the clear ink onto the print medium, and to form a code image on the print medium with the clear ink. It is therefore possible to achieve property modification of the print medium and improvement of security of the colored image on the print medium while reducing manufacturing cost of the apparatus.

According to a preferred embodiment of the present invention, the print medium is sheet-like or thin plate-like, and on a main surface of the print medium on which a colored image print area to be printed with the colored image is set, the code image is formed on a blank area around the colored image print area. More preferably, forming the code image with the clear ink is performed in parallel with modifying the surface of the print medium with the clear ink by the print controller. Still more preferably, the ejection mechanism passes each position on the print medium once by one-time relative movement of the print medium, to complete forming the code image with the clear ink and modifying the surface of the print medium with the clear ink.

According to another preferred embodiment of the present invention, the print medium is sheet-like or thin plate-like, and the colored image is to be formed on one main surface of the print medium and the code image is formed on the other main surface of the print medium.

In the inkjet printer, the clear ink may be ultraviolet visible ink. There also may be a case the inkjet printer further comprises another ejection mechanism for ejecting fine droplets of colored ink from a plurality of outlets; wherein the another ejection mechanism is controlled together with the moving mechanism by the print controller, to form the colored image on the print medium.

The present invention is also intended for an inkjet printing method.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a view showing an inkjet printer in accordance with a first embodiment;

FIG. 2 is a plan view of a print medium;

FIG. 3 is a flowchart showing an operation flow of printing by the inkjet printer;

FIG. 4 is a view abstractly showing a threshold matrix and an original image;

FIG. 5 is a view showing an inkjet printer in accordance with a second embodiment;

FIG. 6 is a flowchart showing an operation flow of printing by the inkjet printer;

FIG. 7 is a view showing an inkjet printer in accordance with a third embodiment;

FIG. 8 is a flowchart showing an operation flow of printing by the inkjet printer;

FIG. 9 is a view showing an inkjet printer in accordance with a fourth embodiment;

FIG. 10 is a flowchart showing an operation flow of printing by the inkjet printer;

FIG. 11 is a view showing a printer system in accordance with a fifth embodiment.

### DESCRIPTION OF EMBODIMENTS

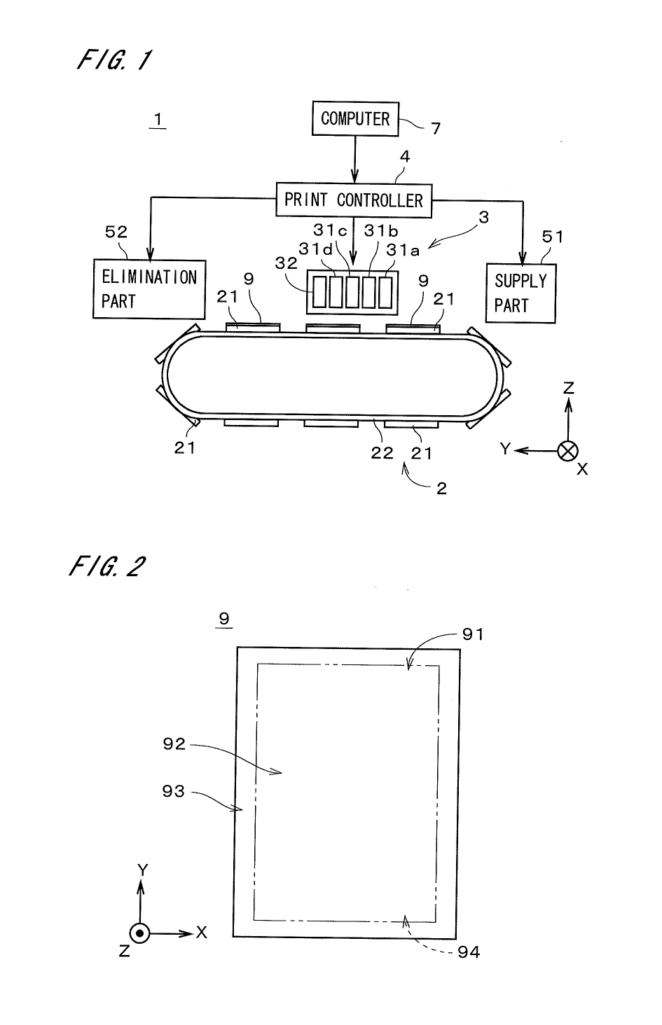

FIG. 1 is a view showing a constitution of an inkjet printer 1 in accordance with a first embodiment of the present invention. The inkjet printer 1 is a sheet-fed printing apparatus for sequentially performing inkjet color printing on a plurality of print mediums 9.

As shown in FIG. 1, the inkjet printer 1 has a moving mechanism 2 for moving the plurality of print mediums 9 in the (+Y) direction in FIG. 1, an ejection part 3 for ejecting fine droplets of ink toward a print medium 9 in the course of conveyance by the moving mechanism 2, a supply part 51 for supplying the print mediums 9 to the moving mechanism 2, an elimination part 52 for receiving the print mediums 9 after completion of printing from the moving mechanism 2, and a print controller 4 for controlling these mechanism.

The moving mechanism 2 has a plurality of stages 21 each of which is for holding one sheet-like print medium 9 (in the present embodiment, the print paper) by suction, a loop-like guide 22 for guiding the plurality of stages 21, and a belt driving mechanism (not shown) for moving a belt inside the guide 22 in a counterclockwise direction in FIG. 1 to move the stages 21 holding the print mediums 9 in the (+Y) direction at the lower side (i.e., the (−Z) side) of the ejection part 3.

The ejection part 3 has five ejection mechanisms 31a to 31d, 32 each of which is for ejecting fine droplets of ink from a plurality of outlets, and the ejection mechanisms 31a to 31d, 32 are arranged in the Y direction in FIG. 1. In the ejection part 3, the ejection mechanism 31a lying on the outermost (−Y) side in FIG. 1 ejects K (black) colored ink, the ejection mechanism 31b at the (+Y) side of the ejection mechanism 31a ejects C (cyan) colored ink, the ejection mechanism 31c at the (+Y) side of the ejection mechanism 31b ejects M (magenta) colored ink, the ejection mechanism 31d at the (+Y) side of the ejection mechanism 31c ejects Y (yellow) colored ink. In addition, in the ejection part 3, the ejection mechanism 32 lying on the outermost (+Y) side in FIG. 1 ejects clear ink. In the present embodiment, invisible ink which is made visible by irradiation of ultraviolet (i.e., ultraviolet visible ink) is utilized as the clear ink.

In the inkjet printer 1, with respect to the X direction orthogonal to the moving direction (the Y direction) of the print medium 9, each ejection mechanism 31a to 31d, 32 in the ejection part 3 is provided across the entire width of the print medium 9 (i.e., across the entire length in the X direction), and the ejection mechanism 31a to 31d, 32 passes each position on the print medium 9 once by one-time relative movement of the print medium 9 toward the (+Y) direction, to complete printing for the print medium 9. In other words, printing without shuttle movement of the print medium 9 in the X direction (so-called one-pass printing) is performed in the inkjet printer 1.

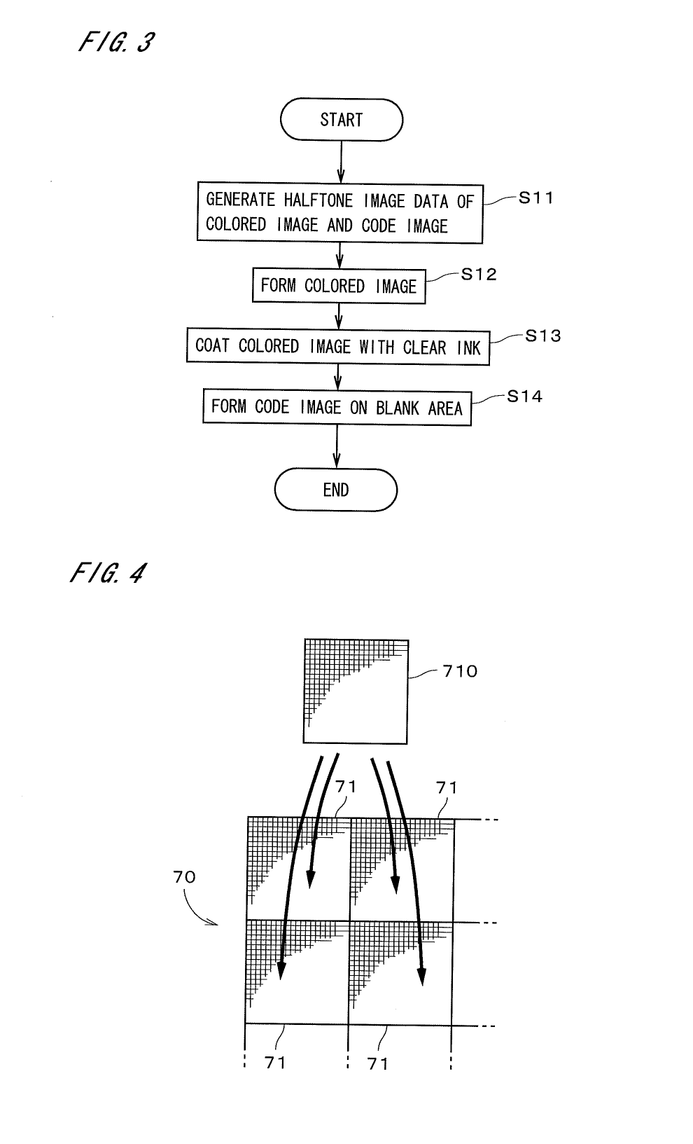

A computer 7 is connected to the inkjet printer 1, and original image data and threshold matrices (also called as SPM (Screen Pattern Memory) data) for formation of halftone screen are sent from the computer 7 to the print controller 4 in the inkjet printer 1. The original image data includes data of grayscale colored image to be formed on a colored image print area 92 which is set on a main surface 91 (hereinafter, referred to as the “first main surface 91”) on the (+Z) side of the print medium 9 shown in FIG. 2 and data of grayscale code image to be formed on a blank area 93 around the colored image print area 92. The code image is an invisible (or hardly visible) image with naked eye in the state where ambient light is irradiated, it is also an image to become visible under a particular circumstance (in the present embodiment, the circumstance where ultraviolet light is irradiated), and it is also called as the invisible image. For example, a corporate logo relating to the print medium 9 or a serial number to specify information relating to manufacture of the print medium 9 is formed as the code image.

FIG. 3 is a flowchart showing an operation flow of printing by the inkjet printer 1. In the inkjet printer 1, halftone image signal representing the colored image (the signal is hereinafter referred to as the “first halftone image data”) and halftone image signal representing the code image (the signal is hereinafter referred to as the “second halftone image data”) are generated by the print controller 4 (see FIG. 1) on the basis of the original image data and the threshold matrices (Step S11). The first halftone image data has halftone image data of each color K, C, M, Y which is generated by color-separating data of colored image included in the original image into respective colors K, C, M, Y and by halftoning the color-separated image data with the threshold matrices.

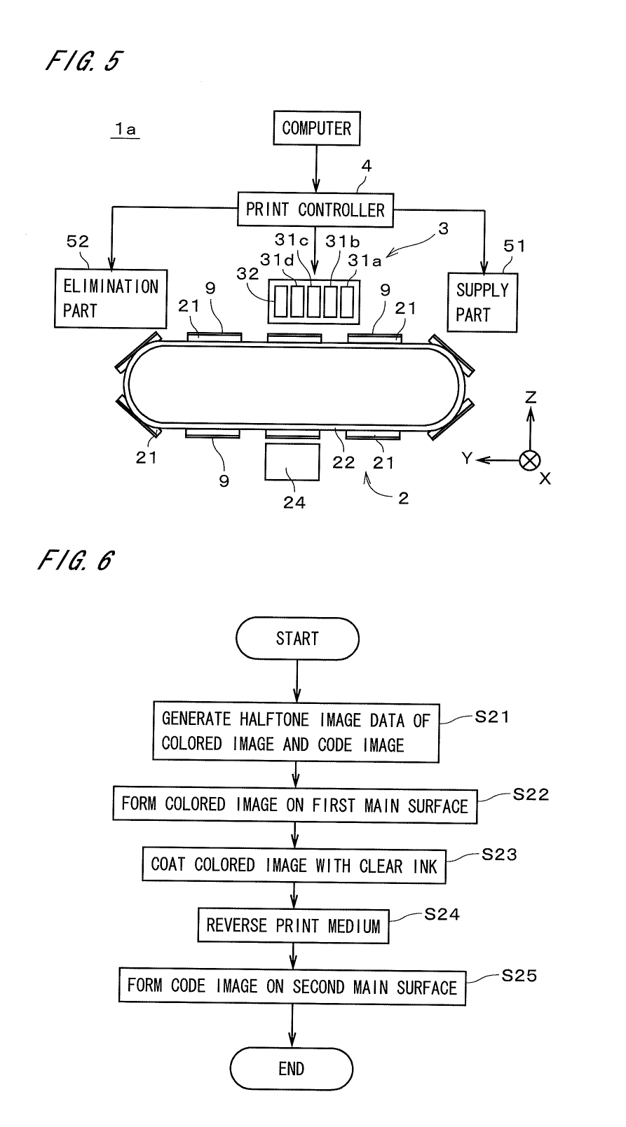

In halftoning of the original image (i.e., in generation of halftone image representing the original image), as shown in FIG. 4, the original image 70 is divided into a large number of areas having the fixed size to set repeat areas 71 each of which serves as a unit in halftoning. The SPM (Screen Pattern Memory) in the print controller 4 has a matrix space (matrix area) which is a memory area corresponding to one repeat area 71 and a threshold value is set to each address of the matrix space (i.e., coordinates (pixel) in the matrix space corresponding to each pixel in the repeat area 71) to generate the threshold matrix 710.

Conceptually, each repeat area 71 of the original image 70 and the threshold matrix 710 are superposed and a gray level of each pixel in the repeat area 71 is compared with a correspondent threshold value in the threshold matrix 710, to thereby determine whether or not formation should be performed (i.e., whether or not a droplet of ink should be ejected) on the position of the pixel on the print medium 9 which is a halftone recording medium. Thus, if gray levels in the original image 70 are uniform, the formation is performed on the pixels of addresses where threshold values less than the gray levels are set in the threshold matrix 710 and uniform halftone dots are generated in broad perspective. Actually, since the original image 70 has gradation (i.e., portions having various gray levels), the state of halftone dots varies in the repeat area 71 in accordance with the gradation in the original image 70.

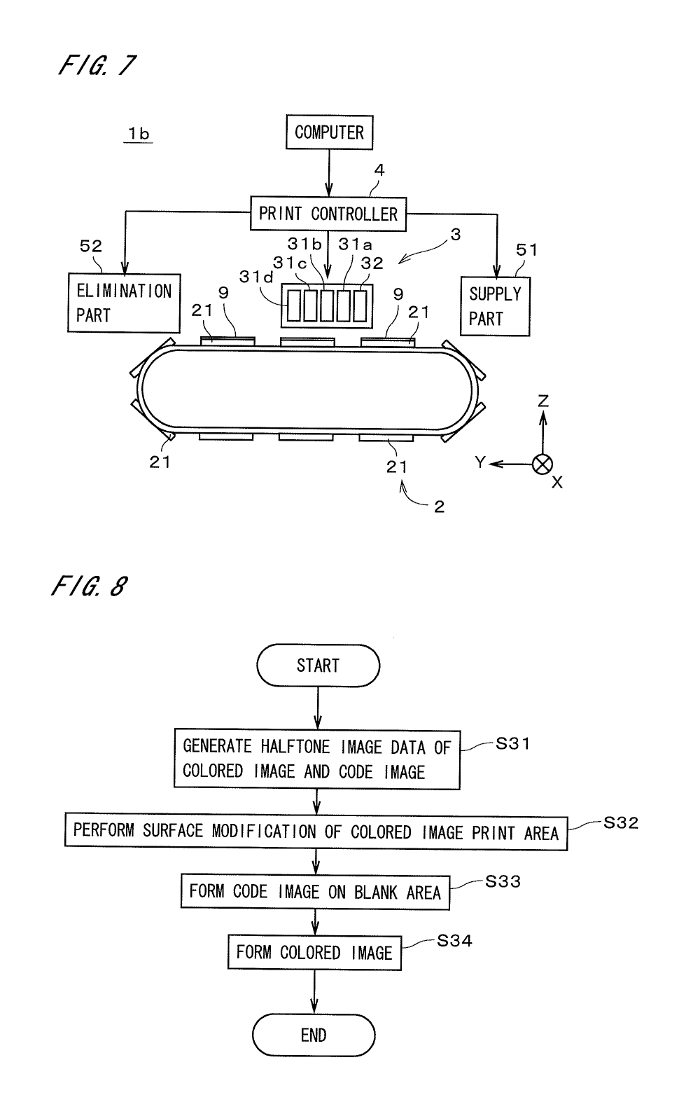

Subsequently, the print medium 9 shown in FIG. 1 is supplied from the supply part 51 onto a stage 21 to be held thereon. Then the moving mechanism 2 and the ejection mechanisms 31a to 31d, 32 in the ejection part 3 are controlled on the basis of the first halftone image data, and therefore colored ink of K, C, M, Y is ejected toward the colored image print area 92 (see FIG. 2) on the first main surface 91 of the print medium 9 moving in the (+Y) direction to form the colored image (Step S12), and the clear ink is ejected onto each dot of the colored image (i.e., each droplet of colored ink applied on the print medium 9) to coat the colored image with the clear ink (to perform so-called overcoating) (Step S13). In the inkjet printer 1, forming of the colored image (Step S12) and coating of the colored image (Step S13) are sequentially performed for each portion of the print medium 9 in the Y direction, and therefore, for the whole print medium 9, forming of the colored image (Step S12) and coating of the colored image (Step S13) are performed almost in parallel (the same applies to after-mentioned Step S22 and Step S23 in FIG. 6).

In Step S13, each dot of the colored image is coated with a dot of clear ink having the same size. In a highlight part of the colored image, the dots of the colored image may be coated with dots of the clear ink having larger size than the dots of the colored image. Therefore, if a landing position of the clear ink (i.e., the position where a droplet of the clear ink is applied) is slightly off from a dot of the colored image, the dot of the colored image is certainly coated with the clear ink. In a tint part of the colored image, there may be a case where the tint part is uniformly coated with the clear ink over the whole surface with no space, and ejection of the clear ink is controlled so that a total area of dots of the clear ink which is applied onto the tint part becomes a predetermined percent of an area of the tint part (the percent is a predetermined percent more than 0% and less than 100%, for example 50%), to apply the clear ink onto the tint part uniformly. Since the total area of dots of the clear ink is made less than the area of the tint part, drying of the colored ink in the tint part is promoted.

In the inkjet printer 1, since the ejection mechanism 32 is controlled on the basis of not only the first halftone image data but also the second halftone image data, the clear ink is ejected toward the blank area 93 on the first main surface 91 of the print medium 9 (in the present embodiment, toward a portion of the blank area 93 lying on the (+X) side or (−X) side of the colored image print area 92) in parallel with coating the colored image with the clear ink in Step S13, to thereby form the code image on the blank area 93 with the clear ink (Step S14). Therefore, on the first main surface 91 of the print medium 9 where the colored image is formed, the coating of the colored image and forming of the code image for the blank area 93 around the colored image (i.e., formation of the code image performed with avoiding the colored image) are performed in parallel, with the identical clear ink ejected from the one ejection mechanism 32.

And the ejection mechanisms 31a to 31d, 32 pass each position on the print medium 9 once by one-time relative movement of the print medium 9 to the ejection part 3 in the (+Y) direction, to complete forming the colored image with the colored ink, coating the colored image with the clear ink and forming the code image with the clear ink. After that, the print medium 9 is withdrawn by the elimination part 52. In the print medium 9 where printing by the inkjet printer 1 is completed, the colored image on the colored image print area 92 is coated with the clear ink and wear resistance of the colored image is improved. In addition, since the code image is formed, strict copying or forging of the print medium 9 printed with the colored image (i.e., strict copying or forging of the colored image and the code image) becomes difficult. As the result, the original print medium 9 is easily distinguished from a copy of the print medium 9 or the like, and security of the colored image on the print medium 9 is improved. In the inkjet printer 1, the above-mentioned printing is sequentially performed for a plurality of print media 9 (the same applies to the following other embodiments).

As described above, in the inkjet printer 1, on the first main surface 91 of the print medium 9 where the colored image is formed, the coating of the colored image and the forming of the code image are performed with the same clear ink ejected from the one ejection mechanism 32. Therefore, structure of the inkjet printer 1 is simplified, and improvement of wear resistance and improvement of security of the colored image can be achieved while reducing manufacturing cost of the apparatus. In addition, printing cost for the print medium 9 can be reduced.

In the inkjet printer 1, since the ultraviolet visible ink is utilized as the clear ink, readout of the code image on the print medium 9 can be easily performed with use of relatively inexpensive and easy-to-use black light or the like, and without using an expensive instrument, equipment or the like. Furthermore, since the code image is made grayscale, inability to detect the code image due to a short ejection amount of the clear ink or exposure of the code image under normal illumination due to an excessive ejection amount of the clear ink is prevented and forming code information with high accuracy is achieved.

In the inkjet printer 1, since the code image is formed with avoiding the colored image, outlets used for the forming of the code image are made different from outlets used for the coating of the colored image in the ejection mechanism 32. Therefore, ejection control of the clear ink from the outlets in the ejection mechanism 32 which are used for the coating of the colored image is performed on the basis of only the first halftone image data, and ejection control of the clear ink from the outlets which are used for the forming of the code image is performed on the basis of only the second halftone image data. As the result, control of the ejection mechanism 32 is simplified. In addition, since the code image is formed on the blank area 93 around the colored image, the coating of the colored image and the forming of the code image can be easily performed in parallel. As the result, the printing for the print medium 9 can be performed quickly.

As above, in the inkjet printer 1, since coating the colored image and forming the code image with the clear ink are performed by one-pass printing, structure of the moving mechanism 2 for moving the print medium 9 relative to the ejection part 3 can be simplified and the printing for the print medium 9 can be performed more quickly.

In the meantime, if forming the colored image for the print medium 9 is performed in an apparatus different from the inkjet printer 1, it is necessary to perform adjustment of relative position between the colored image on the print medium 9 and the ejection mechanism 32 by scanning the colored image with a scanner or the like before ejection of the clear ink for the print medium 9 in the inkjet printer 1. Correspondingly, in the inkjet printer 1 in accordance with the present embodiment, the moving mechanism 2 used for the coating of the colored image and the forming of the code image is controlled together with the ejection mechanisms 31a to 31d of the ejection part 3 by the print controller 4, to perform forming the colored image on the print medium 9. Therefore, adjustment of relative position between the colored image and the ejection mechanism 32 as described above is made unnecessary, and the coating of the colored image and the forming of the code image are simplified. Furthermore, since the forming of the colored image is performed by the same inkjet method as that for the coating of the colored image and the forming of the code image, structure of the ejection part 3 can be simplified. In addition to that, since the forming of the colored image is performed almost in parallel with the coating of the colored image and the forming of the code image (in more detail, while preceding them slightly, almost in parallel with them), the printing for the print medium 9 is performed more quickly.

In the above embodiment, it is described that the code image is formed on the blank area 93 around the colored image on the first main surface 91 of the print medium 9 shown in FIG. 2. However, in the inkjet printer 1, a code image may be formed on the colored image formed on the colored image print area 92. When forming the code image on the colored image, for example in Steps S13, S14, ejection amounts of the clear ink from a group of outlets, which is opposed to the colored image print area 92, in the ejection mechanism 32 are set at a predetermined amount so as to uniformly coat the whole colored image print area 92 with the clear ink with no space, and furthermore, control to increase the ejection amount of the clear ink from an outlet, which corresponds to each dot of the code image, by approximately 20% to 30% of the above predetermined amount is performed by the print controller 4 on the basis of the second halftone image data.

Therefore, the colored image print area 92 where the colored image is formed is coated with the clear ink over the whole surface, and heights of portions, corresponding to the code image, in the coating layer of the clear ink are made higher than that of the surround. As above, since the code image is formed on the colored image, visual recognition of the code image can be made more difficult in the state where ambient light is irradiated. The code image may be formed on both the colored image and the blank area 93.

Next, discussion will be made on an inkjet printer in accordance with a second embodiment of the present invention. FIG. 5 is a view showing a constitution of the inkjet printer 1a in accordance with the second embodiment. The constituents of the inkjet printer 1a are same as those of the inkjet printer 1 shown in FIG. 1 except for the point where the moving mechanism 2 has a reversal mechanism 24 at the lower side of the guide 22, and in the following description, constituents corresponding to respective constituents of the inkjet printer 1 are denoted by the same reference signs.

FIG. 6 is a flowchart showing an operation flow of printing by the inkjet printer 1a. In the inkjet printer 1a, the first halftone image data representing the colored image and the second halftone image data representing the code image are generated in the print controller 4 in the same manner as the first embodiment (Step S21). Subsequently, the print medium 9 is supplied from the supply part 51 onto a stage 21 to be held thereon, and the moving mechanism 2 and the ejection mechanisms 31a to 31d, 32 in the ejection part 3 are controlled by the print controller 4, thereby to form the colored image on the colored image print area 92 (see FIG. 2) of the first main surface 91 of the print medium 9 (Step S22) and to perform coating the colored image with the clear ink (Step S23).

The print medium 9 where the forming of the colored image and the coating of the colored image are completed moves in a counterclockwise direction in FIG. 5 by movement of the belt inside the guide 22 of the moving mechanism 2, and it reaches at the reversal mechanism 24 without being withdrawn by the elimination part 52. The print medium 9 is reversed by the reversal mechanism 24, and the first main surface 91 which is one main surface on which the colored image has been formed is held on the stage 21 by suction (Step S24).

After that, since the belt inside the guide 22 further moves, the print medium 9 moves in the counterclockwise direction to lie at the lower side of the ejection part 3 and a second main surface 94 (see FIG. 2) of the print medium 9 which is the other main surface is opposite to the ejection mechanism 32. In the inkjet printer 1a, the moving mechanism 2 and the ejection mechanism 32 are controlled by the print controller 4, and therefore ejection of the clear ink toward the second main surface 94 of the print medium 9 is performed to perform forming of the code image on the second main surface 94 (Step S25). The print medium 9 where the forming of the code image is completed is withdrawn by the elimination part 52.

In the print medium 9, wear resistance of the colored image is improved by coating the colored image with the clear ink, and security of the colored image on the print medium 9 is improved by forming the code image in a similar fashion to the first embodiment. In the inkjet printer 1a, the coating of the colored image and the forming of the code image are performed with the same clear ink ejected from the one ejection mechanism 32 in a similar fashion to the inkjet printer 1. Therefore, improvement of wear resistance and improvement of security of the colored image can be achieved while reducing manufacturing cost of the apparatus without complicating structure of the inkjet printer 1a. In addition, printing cost for the print medium 9 can be reduced.

In the inkjet printer 1a, the code image is formed on the second main surface 94 which is different from the first main surface 91 on which the colored image is formed. Thus, when controlling ejection of the clear ink from the ejection mechanism 32, it becomes unnecessary to merge the first halftone image data with the second halftone image data. Consequently, control of the ejection mechanism 32 is simplified.

In the inkjet printer 1a, there may be a case where forming the code image for the second main surface 94 is first performed, and then forming the colored image and coating the colored image for the first main surface 91 are performed. In addition to forming the code image on the second main surface 94, forming code image may be performed on the blank area 93 of the first main surface 91 or on the colored image.

Next, discussion will be made on an inkjet printer in accordance with a third embodiment of the present invention. FIG. 7 is a view showing a constitution of the inkjet printer 1b in accordance with the third embodiment. The constituents of the inkjet printer 1b are same as those of the inkjet printer 1 shown in FIG. 1 except for the point where in the ejection part 3, the ejection mechanism 32 for ejecting the clear ink is located at the (−Y) side of the ejection mechanism 31a to 31d for ejecting the colored ink K, and in the following description, constituents corresponding to respective constituents of the inkjet printer 1 are denoted by the same reference signs.

In the inkjet printer 1b, the clear ink is uniformly ejected on the print medium 9 before forming of the colored image, and therefore modifying a surface of the print medium 9 to be printed with the colored image is performed (so-called undercoating is performed). Hereinafter, discussion will be made on an operation flow of printing by the inkjet printer 1b with reference to FIG. 8. In the inkjet printer 1b, the first halftone image data representing the colored image and the second halftone image data representing the code image are generated in the print controller 4 in the same manner as the first embodiment (Step S31).

Subsequently, the print medium 9 is supplied from the supply part 51 onto a stage 21 to be held thereon, and the moving mechanism 2 and the ejection mechanism 32 in the ejection part 3 are controlled by print controller 4. Therefore, the clear ink is uniformly ejected from outlets, which are opposed to the colored image print area 92 (see FIG. 2) of the print medium 9 on which the colored image is to be formed, out of the plurality of outlets in the ejection mechanism 32 toward the colored image print area 92, to perform surface modification of the colored image print area 92 on the first main surface 91 (see FIG. 2) of the print medium 9 (Step S32). In addition, ejection of the clear ink from outlets, which are opposed to the blank area 93 (see FIG. 2) around the colored image print area 92, out of the plurality of outlets in the ejection mechanism 32, is controlled on the basis of the second halftone image data, to thereby form the code image on the blank area 93 (i.e., with avoiding the colored image print area 92) in parallel with Step S32 (Step S33).

In the inkjet printer 1b, since the moving mechanism 2 and the ejection mechanisms 31a to 31d of the ejection part 3 are controlled by the print controller 4, the colored ink is ejected toward portions of the colored image print area 92 (i.e., the colored image print area 92 after the surface modification) having passed under the ejection mechanism 32, to perform forming of the colored image (Step S34). In the inkjet printer 1b, modifying the surface and forming the code image (Step S32, S33), and forming the colored image (Step S34) are sequentially performed on each portion of the print medium 9 in the Y direction, and therefore for the whole print medium 9, modifying the surface and forming the code image (Step S32, S33), and forming the colored image (Step S34) are performed in almost parallel.

In the inkjet printer 1b, the ejection mechanisms 32, 31a to 31d pass each position on the print medium 9 once by one-time relative movement of the print medium 9 to the ejection part 3 toward the (+Y) direction, to complete the surface modification of the print medium 9 with the clear ink, the forming of the code image with the clear ink and the forming of the colored image with the colored ink. After that, the print medium 9 is withdrawn by the elimination part 52.

In the print medium 9 where printing by the inkjet printer 1b is completed, since the surface modification with the clear ink is performed on the colored image print area 92 before forming the colored image, the surface of the colored image print area 92 becomes the suitable condition for the colored ink used for the forming of the colored image. As the result, forming high accuracy and high quality colored image on the colored image print area 92 is achieved. In addition, since the code image is formed on the print medium 9, copying or forging of the print medium 9 printed with the colored image becomes difficult and security of the colored image on the print medium 9 is increased.

In the inkjet printer 1b, the surface modification of the print medium 9 and the forming of the code image are performed with the same clear ink ejected from the one ejection mechanism 32. Therefore, the surface modification of the print medium 9, the forming of high accuracy and high quality colored image by the modification, and improvement of security of the colored image on the print medium 9 can be achieved while reducing manufacturing cost of the apparatus without complicating structure of the inkjet printer 1b. In addition, printing cost for the print medium 9 can be reduced.

As described above, in the inkjet printer 1b, the code image is formed on the blank area 93 around the colored image, the surface modification of the print medium 9 can be easily performed in parallel with the forming of the code image. Therefore, the printing for the print medium 9 can be performed quickly. In the inkjet printer 1b, the surface modification with the clear ink may be also performed on the blank area 93. In this case, for example, ejection amounts of the clear ink from a group of outlets, which is opposed to the blank area 93, in the ejection mechanism 32 are set at a predetermined amount so as to uniformly eject the clear ink on the blank area 93, and furthermore, control to increase the ejection amount of the clear ink from an outlet, which corresponds to each dot of the code image, by approximately 20% to 30% of the above predetermined amount is performed by the print controller 4 on the basis of the second halftone image data.

In the inkjet printer 1b, since the ultraviolet visible ink is utilized as the clear ink, readout of the code image on the print medium 9 can be easily performed in the same manner as the first embodiment. In addition, since the code image is made grayscale, forming code information with high accuracy is achieved.

In the meantime, if forming the colored image for the print medium 9 is performed in an apparatus different from the inkjet printer 1b, it is necessary to obtain positional information of the colored image print area 92 on the print medium 9 and to adjust relative position between the ejection mechanism in the apparatus used for forming the colored image and the colored image print area 92 before the forming of the colored image. Correspondingly, in the inkjet printer 1b in accordance with the present embodiment, the moving mechanism 2 used for the surface modification of the print medium 9 and the forming of the code image is controlled together with the ejection mechanisms 31a to 31d in the ejection part 3 by the print controller 4, to perform the forming of the colored image on the print medium 9. Therefore, adjustment of relative position between the colored image print area 92 and the ejection mechanism in the apparatus used for forming the colored image as described above is made unnecessary, and the forming of the colored image is simplified. Furthermore, since the forming of the colored image is performed by the same inkjet method as that for the surface modification of the print medium 9 and the forming of the code image, structure of the ejection part 3 can be simplified. In addition to that, since the forming of the colored image is performed almost in parallel with the surface modification of the print medium 9 and the forming of the code image, the printing for the print medium 9 is performed more quickly.

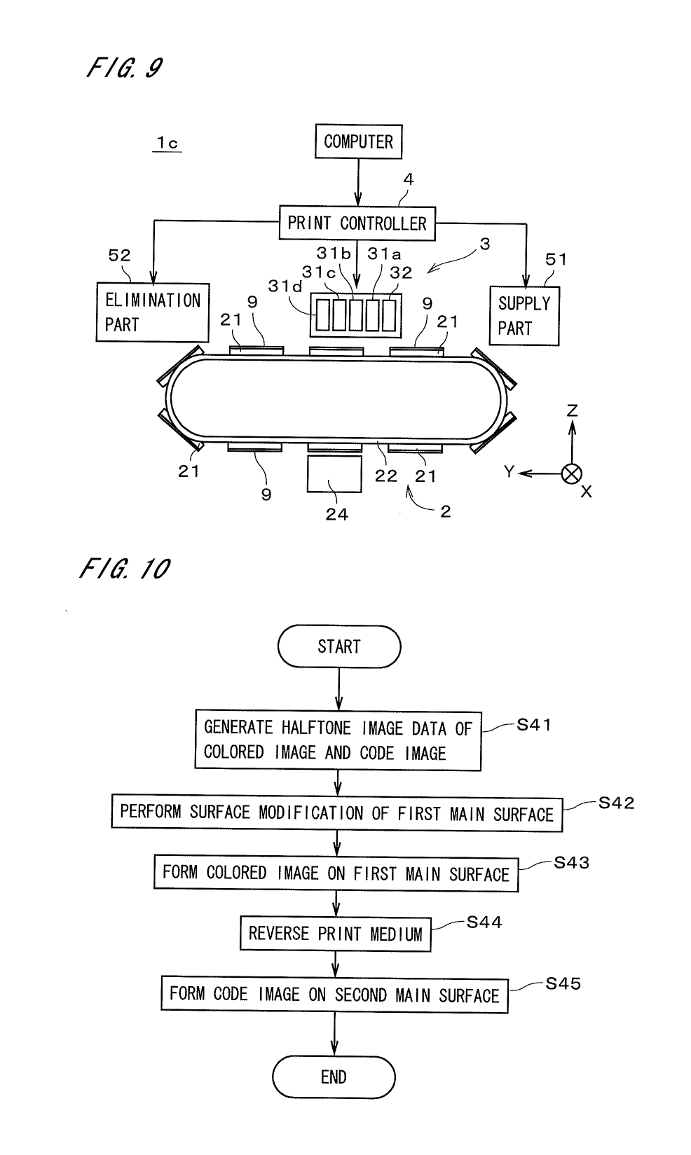

Next, discussion will be made on an inkjet printer in accordance with a fourth embodiment of the present invention. FIG. 9 is a view showing a constitution of the inkjet printer 1c in accordance with the fourth embodiment. The constituents of the inkjet printer 1c are same as those of the inkjet printer 1b shown in FIG. 7 except for the points where the same reversal mechanism 24 as that in the inkjet printer 1a (see FIG. 5) in accordance with the second embodiment is provided under the guide 22 and the code image is formed on the second main surface 94 (see FIG. 2) of the print medium 9. In the following description, constituents corresponding to respective constituents of the inkjet printer 1b are denoted by the same reference signs.

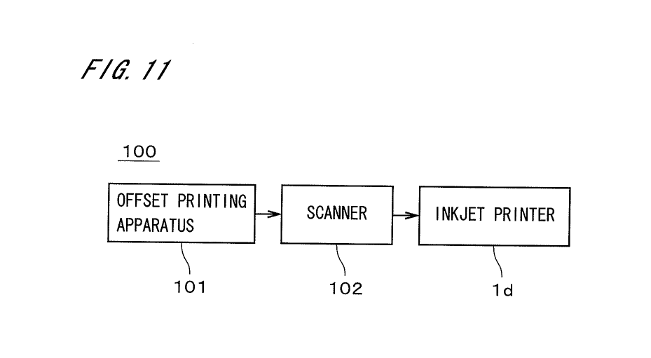

As shown in FIG. 10, in the inkjet printer 1c, the first halftone image data representing the colored image and the second halftone image data representing the code image are generated in the print controller 4 (Step S41). Subsequently, the print medium 9 is supplied from the supply part 51 onto a stage 21 to be held thereon, and the moving mechanism 2 and the ejection mechanisms 32, 31a to 31d in the ejection part 3 are controlled by print controller 4. Therefore, the clear ink is uniformly ejected toward the colored image print area 92 (see FIG. 2) of the print medium 9 to perform surface modification of the colored image print area 92, and the colored image is formed on the colored image print area 92 after the surface modification (Step S42, S43).

The print medium 9 where the surface modification and the forming of the colored image are completed reaches at the reversal mechanism 24 without being withdrawn by the elimination part 52, and it is reversed by the reversal mechanism 24 (Step S44). After that, the print medium 9 moves to the lower side of the ejection part 3 and the moving mechanism 2 and the ejection mechanism 32 are controlled by the print controller 4 to perform forming of the code image on the second main surface 94 of the print medium 9 (Step S45). The print medium 9 where the forming of the code image is completed is withdrawn by the elimination part 52.

In the inkjet printer 1c, the surface modification of the print medium 9 and the forming of the code image are performed with the same clear ink ejected from the one ejection mechanism 32. Therefore, the surface modification of the print medium 9 and the forming of high accuracy and high quality colored image by the modification, and improvement of security of the colored image on the print medium 9 can be achieved while reducing manufacturing cost of the apparatus without complicating structure of the inkjet printer 1c in a similar fashion to the third embodiment. In addition, printing cost for the print medium 9 can be reduced. Furthermore, control of the ejection mechanism 32 is simplified since the code image is formed on the second main surface 94.

Next, discussion will be made on an inkjet printer in accordance with a fifth embodiment of the present invention. FIG. 11 is a view showing a constitution of a printer system 100 having the inkjet printer 1d in accordance with the fifth embodiment. As shown in FIG. 11, the printer system 100 has an offset printing apparatus 101 and a scanner 102 in addition to the inkjet printer 1d. The constituents of the inkjet printer 1d are same as those of the inkjet printer 1 shown in FIG. 1 except for the points where the ejection mechanism 31a to 31d for ejecting the colored ink are not provided in the ejection part 3. In the following description, constituents corresponding to respective constituents of the inkjet printer 1 are denoted by the same reference signs.

In the printer system 100, the colored image is printed on the colored image print area 92 (see FIG. 2) of the print medium 9 by the offset printing apparatus 101, and the first main surface 91 (see FIG. 2) of the print medium 9 printed with the colored image is scanned by the scanner 102. In the inkjet printer 1d, on the basis of information indicating dot positions of the colored ink in the colored image print area 92 and a position of the blank area 93 (see FIG. 2) which are obtained from output of the scanner 102, the moving mechanism 2 and the ejection mechanism 32 (see FIG. 1) in the ejection part 3 are controlled by the print controller 4, to coat the colored image on the colored image print area 92 with the clear ink and to form the code image with the clear ink on the blank area 93.

In the inkjet printer 1d of the printer system 100, on the first main surface 91 of the print medium 9 where the colored image has been formed, the coating of the colored image and the forming of the code image are performed with the same clear ink ejected from the one ejection mechanism 32 in a similar fashion to the first embodiment. Therefore, improvement of wear resistance and improvement of security of the colored image can be achieved while reducing manufacturing cost of the apparatus without complicating structure of the inkjet printer 1d.

In the printer system 100, if print information of the colored image in the offset printing apparatus 101 (i.e., the information indicating dot positions of the colored ink) and information indicating a position of the blank area 93 on the print medium 9 are obtained in advance, the scanner 102 may be omitted. Also another printing apparatus such as an electrophotographic printer may be provided as substitute for the offset printing apparatus 101.

In the inkjet printer 1d, if the whole area of the colored image print area 92 is uniformly coated with the clear ink or the like, approximate positions of the colored image print area 92 and the blank area 93 have only to be detectable. Thus, as long as a guide for performing alignment of the print medium 9 by contacting edges of the print medium 9 or the like is provided in each stage 21 of the inkjet printer 1d, the scanner 102 can be omitted from the printer system 100.

Though the preferred embodiments of the present invention have been discussed above, the present invention is not limited to the above-discussed preferred embodiments, but allows various variations.

In the inkjet printers in accordance with the third and fourth embodiments, there may be a case where an ejection mechanism for ejecting the clear ink is provided also at the (+Y) side of the ejection mechanism 31d in the ejection part 3 and coating the colored image with the clear ink is performed as appropriate.

The inkjet printers in accordance with the first to fourth embodiments may be utilized as a monochrome printer by omitting the ejection mechanism 31b to 31d from the ejection part 3. The code image may be formed by not multi-level dots (i.e., dots having a plurality of sizes) of the clear ink but one sized dots.

In the inkjet printers in accordance with the above-discussed embodiments, there may be a case where a width of each ejection head in the ejection part 3 in the X direction is made less than the width of the print medium 9 in the X direction, shuttle movement of the ejection part 3 in the X direction and movement of the print medium 9 toward the (+Y) direction are performed in parallel, and therefore printing for the print medium 9 is performed. The moving mechanism 2 do not always have to be a mechanism for moving the print medium 9, for example, it may be a mechanism for moving the ejection part 3 (i.e., the ejection mechanisms 31a to 31d, 32) to move the print medium 9 relative to the ejection part 3.

In the above-discussed inkjet printers, for example, printing may be performed for a web which is continuous paper. In the inkjet printer, printing is not necessarily performed on the sheet-like print medium 9 such as paper or film, and printing may be performed on print media in various forms such as a thin plate-like print medium or others.

While the invention has been shown and described in detail, the foregoing description is in all aspects illustrative and not restrictive. It is therefore understood that numerous modifications and variations can be devised without departing from the scope of the invention.

### REFERENCE SIGNS LIST

1, 1a to 1d inkjet printer
2 moving mechanism
4 print controller
9 print medium
32 ejection mechanism
91 first main surface
92 colored image print area
93 blank area
94 second main surface
S11 to S14, S21 to S25, S31 to S34, S41 to S45 step

1. An inkjet printer, comprising:
an ejection mechanism for ejecting fine droplets of clear ink from a plurality of outlets;
a moving mechanism for moving a print medium relative to said ejection mechanism; and
a print controller which controls said ejection mechanism and said moving mechanism, to coat a colored image on said print medium with said clear ink and to form a code image on said colored image with said clear ink on the basis of second halftone image data, said colored image being formed on the basis of first halftone image data.

2-5. (canceled)

6. An inkjet printer comprising:
an ejection mechanism for ejecting fine droplets of clear ink from a plurality of outlets;
a moving mechanism for moving a print medium relative to said ejection mechanism, said print medium being sheet-like or thin plate-like; and
a print controller which controls said ejection mechanism and said moving mechanism, to coat a colored image on said print medium with said clear ink and to form a code image on said print medium with said clear ink, wherein
said colored image is formed on one main surface of said print medium and said code image is formed on the other main surface of said print medium.

7. The inkjet printer according to claim 1, wherein said clear ink is ultraviolet visible ink.

8. The inkjet printer according to claim 1, further comprising another ejection mechanism for ejecting fine droplets of colored ink from a plurality of outlets;
wherein said another ejection mechanism is controlled together with said moving mechanism by said print controller, to form said colored image on said print medium.

9. An inkjet printer, comprising:
an ejection mechanism for ejecting fine droplets of clear ink from a plurality of outlets;
a moving mechanism for moving a print medium relative to said ejection mechanism, said print medium being sheet-like or thin plate-like; and
a print controller which controls said ejection mechanism and said moving mechanism to modify a surface of said print medium, to be printed with a colored image, by uniformly ejecting said clear ink onto said print medium, and to form a code image on said print medium with said clear ink, wherein
said colored image is formed on one main surface of said print medium and said code image is formed on the other main surface of said print medium.

10-13. (canceled)

14. The inkjet printer according to claim 9, wherein said clear ink is ultraviolet visible ink.

15. The inkjet printer according to claim 9, further comprising
another ejection mechanism for ejecting fine droplets of colored ink from a plurality of outlets; wherein
said another ejection mechanism is controlled together with
said moving mechanism by said print controller, to form said colored image on said print medium.

16. An inkjet printing method, comprising the steps of:
a) ejecting fine droplets of clear ink from a plurality of outlets in an ejection mechanism and moving a print medium relative to said ejection mechanism, to coat a colored image on said print medium with said clear ink, said colored image being formed on the basis of first halftone image data; and
b) ejecting fine droplets of said clear ink from said plurality of outlets and moving said print medium relative to said ejection mechanism, to form a code image on said colored image with said clear ink on the basis of second halftone image data.

17. An inkjet printing method, comprising the steps of:
a) uniformly ejecting clear ink onto a print medium by ejecting fine droplets of said clear ink from a plurality of outlets in an ejection mechanism and moving said print medium relative to said ejection mechanism, to modify a surface of said print medium to be printed with a colored image, said print medium being sheet-like or thin plate-like; and
b) ejecting fine droplets of said clear ink from said plurality of outlets and moving said print medium relative to said ejection mechanism, to form a code image on said print medium with said clear ink, wherein
said colored image is formed on one main surface of said print medium and said code image is formed on the other main surface of said print medium.

18. The inkjet printer according to claim 6, wherein said clear ink is ultraviolet visible ink.

19. The inkjet printer according to claim 6, further comprising
another ejection mechanism for ejecting fine droplets of colored ink from a plurality of outlets; wherein
said another ejection mechanism is controlled together with said moving mechanism by said printer controller, to form said colored image on said print medium.

20. An inkjet printing method, comprising the steps of:
a) ejecting fine droplets of clear ink from a plurality of outlets in an ejection mechanism and moving a print medium relative to said ejection mechanism, to coat a colored image on said print medium with said clear ink, said print medium being sheet-like or thin plate-like; and
b) ejecting fine droplets of said clear ink from said plurality of outlets and moving said print medium relative to said ejection mechanism, to form a code image on said print medium with said clear ink, wherein
said colored image is formed on one main surface of said print medium and said code image is formed on the other main surface of said print medium.

21. The inkjet printing method according to claim 16, wherein said clear ink is ultraviolet visible ink.

22. The inkjet printing method according to claim 20, wherein said clear ink is ultraviolet visible ink.

23. The inkjet printing method according to claim 16, further comprising the step of
c) ejecting fine droplets of colored ink from a plurality of outlets in another ejection mechanism and moving said print medium relative to said another ejection mechanism, to form said colored image on said print medium, before said step a).

24. The inkjet printing method according to claim 20, further comprising the step of
c) ejecting fine droplets of colored ink from a plurality of outlets in another ejection mechanism and moving said print medium relative to said another ejection mechanism, to form said colored image on said print medium, before said step a).

25. The inkjet printing method according to claim 17, wherein said clear ink is ultraviolet visible ink.

26. The inkjet printing method according to claim 17, further comprising the step of
c) ejecting fine droplets of colored ink from a plurality of outlets in another ejection mechanism and moving said print medium relative to said another ejection mechanism, to form said colored image on said print medium, after said step a).
